(19) United States
(12) Patent Application Publication
(10) Pub. No.: US 2023/0196522 A1
(43) Pub. Date: Jun. 22, 2023

(54) PLENOPTIC IMAGE TILE ORGANIZATION FOR SINGLE IMAGE DISPLAY OR CAPTURE

(71) Applicant: Soliddd Corp., Brooklyn, NY (US)

(72) Inventors: Neal Weinstock, Brooklyn, NY (US); William N. Stubbs, Brooklyn, NY (US)

(21) Appl. No.: 17/554,779

(22) Filed: Dec. 17, 2021

(51) Int. Cl. G06T 5/00; G06T 3/40; G06F 3/01

(52) U.S. Cl. CPC G06T 5/006; G06F 3/013; G06T 3/40

(57) ABSTRACT

One embodiment provides a method, including: obtaining an image for display on a display device including at least one plenoptic lens; calibrating the image in view of properties of the at least one plenoptic lens, wherein the calibrating includes centering image tiles corresponding to portions of the image on corresponding lens tiles of the at least one plenoptic lens; creating a unified image from the image tiles of the calibrated image by adjusting at least one attribute of the image tiles to control a portion of the image displayed through each of the lens tiles of the at least one plenoptic lens, wherein at least a portion of the adjusting is based upon a distance of an eye of a user to the display device; and displaying the unified image on the display device including the at least one plenoptic lens. Other embodiments are described herein.

### FIELD OF THE INVENTION

The present invention relates generally to image capture systems and image display systems, more particularly, to image capture device systems and image display systems that utilize plenoptic lenses able to present discreet images from each lens in the array in focus on the viewer’s retina without engaging the normal focusing action of the eye’s pupil.

### BACKGROUND OF THE INVENTION

Many digital cameras and several kinds of displays employ a two-dimensional lens array in front of the sensor (in a camera) or the display (in a monitor, television, smartphone, near-eye headset, or other kind of display device). The lens array, being a lenticular array, a microlens array, a plenoptic lens, one of multiple elements in a plenoptic or light-field system, or other arrangement, often may be used to focus light on the sensor or from the display such that redundant information, or overlapping images, are captured or displayed by multiple lenslets in the array and thus multiple areas of the underlying sensor or display.

A plenoptic lens such as that described in U.S. Pat. Application having Serial No. 16/712,425, titled “PLENOPTIC INTEGRAL IMAGING LIGHT FIELD, FULL-FOCUS, SINGLE-ELEMENT VOLUMETRIC CAPTURE LENS AND SYSTEM” and filed on Dec. 12, 2019, and U.S. Pat. Application having Serial No. 16/436,343, titled “NEAR-EYE FOVEAL DISPLAY” and filed on Jun. 10, 2019, the contents of both of which are incorporated by reference herein, features a flat array of spherical lenses shaved into square lens tiles and focuses light onto the sensor or display. Thus, the plenoptic lens contains a plurality of lens tiles and creates multiple images in an array across a sensor when the plenoptic lens is used for image capture. When the at least one plenoptic lens is used for display, the plurality of lens tiles shows multiple images across a display. The multiple images must be combined together to form a final image to be captured or viewed by a user.

### SUMMARY OF THE INVENTION

Since each lens tile captures or displays a portion of the overall image, the multiple images that are captured or displayed by the plenoptic lens must be adjusted so that the final image captured or displayed to the viewer appears to be a single unified image without any distortion in the image. Additionally, the distance a user is away from a display during image viewing or the image is from the plenoptic lens during image capture may affect the adjustments that need to be made to the images so that the image can be properly captured or properly displayed so that the image appears to be a single unified image without image distortion. Additionally, since multiple images are captured, there may be overlap between images captured by different lenses. The amount of overlap may vary based upon the distance of the user to the displayed image or the distance of the image to the image capture sensor. Generally, the closer the image to the image capture sensor or the user to the display, the more overlap is present between images captured by or generated by the plenoptic lens.

The system and method described herein provides a novel technique for generating a single, unified image for display on a display device including a plenoptic lens or capturing a single, unified image using an image capture sensor including a plenoptic lens. The algorithm described herein and used by a described system and method, properly sizes, places, and warps the multiple images to present a single, unified image to the eye, either as a displayed image or as a captured image. The described system and method may also take additional steps to reduce image distortion and defects in order to provide a more quality captured and/or displayed image.

Additionally, in order to reduce the amount of image processing and bandwidth required to capture and display a single, unified image from the multiple images captured and generated by the plenoptic lens, the described system and method is able to utilize an algorithm to determine which portions of the image can be omitted. For example, the sizing, placement, and warping of each of the multiple images generated or captured by the plenoptic lens can provide an indication of which portion of the image can be omitted.

While capturing an image using an image capture sensor including a plenoptic lens and displaying an image using a display device including a plenoptic lens are discussed as two separate embodiments, it should be apparent that the processing performed on either the captured image or on the displayed image employs the same steps. In other words, the algorithm and method that is described herein is equally applicable to capturing an image as it is to displaying an image.

Thus, the described system and method provides a novel technique that properly captures and/or displays a single, unified image from multiple images that are the result of the use of a plenoptic lens, while reducing the amount of processing and bandwidth required for the processing. The system obtains an image for display on a display device including at least one plenoptic lens. Alternatively, the system can capture, using an image capture sensor including a plenoptic lens, an image. The multiple images generated by the plenoptic lens are calibrated to center image tiles corresponding to portions of the image with lens tiles of the plenoptic lens. The system creates a unified image from the image tiles of the calibrated image by adjusting one or more attributes of the image tiles to control a portion of the image that is displayed through each of the lens tiles of the plenoptic lens. Each of the images captured by lens tiles of the plenoptic lens are processed to align with image tiles that correspond to a portion of the captured or displayed image. Some example attributes include image tile size and distortion adjustment attributes. The adjustment of the attributes may be based upon a distance or location of an eye of a user to the display device in the case of displaying the image or, in the case of capturing an image, a distance or location of an image with respect to the image capture sensor.

The system may also modify characteristics of either the image tile(s) or lens tile(s). The characteristics are not based upon a distance or location of the eye of the user to the display or the image to the image capture sensor. The characteristic modifications may increase the quality of the image, for example, by removing additional distortion, aligning the plenoptic lens to the display or image capture sensor, zooming, or the like. Once the attributes are adjusted and/or the characteristics are modified, the system can either display the unified image or capture the unified image.

In summary, one aspect provides a method, including; obtaining an image for display on a display device including at least one plenoptic lens; calibrating the image in view of properties of the at least one plenoptic lens, wherein the calibrating includes centering image tiles corresponding to portions of the image on corresponding lens tiles of the at least one plenoptic lens; creating a unified image from the image tiles of the calibrated image by adjusting at least one attribute of the image tiles to control a portion of the image displayed through each of the lens tiles of the at least one plenoptic lens, wherein at least a portion of the adjusting is based upon a distance of an eye of a user to the display device; and displaying the unified image on the display device including the at least one plenoptic lens.

Another aspect provides a method, including; capturing, using at least one image capture sensor comprising at least one plenoptic lens, an image, wherein the capturing includes: receiving multiple portions of the image, wherein each of the multiple portions is generated by a lens tile of the at least one plenoptic lens; calibrating the image in view of properties the at least one plenoptic lens, wherein the calibrating includes centering image tiles on corresponding lens tiles of the at least one plenoptic lens, each of the image tiles corresponding to one of the multiple portions of the image; and creating a unified image from the image tiles of the calibrated image by adjusting at least one attribute of the image tiles to control a portion of the image captured through each of the lens tiles, wherein at least a portion of the adjusting is based upon a distance of the at least one image capture sensor to the image.

Another aspect provides an information handling device, including: a gaze detection sensor; a display; at least one plenoptic lens disposed on the display, wherein each of the at least one plenoptic lens comprises a plurality of lens tiles that cover a portion of the display; a processor; a memory device that stores instructions executable by the processor to: obtain an image for display on the display device; calibrate the image in view of properties of the at least one plenoptic lens, wherein the calibrating comprises centering image tiles corresponding to portions of the image on corresponding of the plurality of lens tiles of the at least one plenoptic lens; create a unified image from the image tiles of the calibrated image by adjusting at least one attribute of the image tiles to control a portion of the image displayed through each of the lens tiles of the at least one plenoptic lens, wherein at least a portion of the adjusting is based upon a distance of an eye of a user to the display device as detected using the gaze detection sensor; and display the unified image on the display device.

### A BRIEF DESCRIPTION OF THE DRAWINGS

FIG. 1 illustrates a block diagram showing an example apparatus device.

FIG. 2 illustrates an example method for creating a unified image for display on a display device having a plenoptic lens.

FIG. 3 illustrates an example method for capturing a unified image using a plenoptic lens.

FIG. 4 illustrates a series of nine image tiles, each showing exactly the same image.

FIG. 5 illustrates a view of the nine image tiles of FIG. 4 with image centers displaced.

FIG. 6 illustrates a view of the nine image tiles of FIG. 4 and adjusted in FIG. 5 with the center tile image enlarged.

FIG. 7 illustrates a view of the nine image tiles of FIG. 4 and adjusted in FIG. 5 and FIG. 6 with the surrounding tiles being reduced in size.

FIG. 8 illustrates a view of the nine image tiles of FIG. 4 and adjusted in FIG. 5, FIG. 6, and FIG. 7 with the surrounding tiles being adjusted for trapezoidal distortion.

FIG. 9 illustrates a view of the nine image tiles of FIG. 4 and adjusted in FIG. 5, FIG. 6, FIG. 7, and FIG. 8 with barrel or pincushion distortion added for each image tile.

FIG. 10 illustrates a view of the nine image tiles of FIG. 4 and adjusted in FIG. 5, FIG. 6, FIG. 7, FIG. 8, and FIG. 9 with distances from the center tile spread out.

FIG. 11 illustrates a view of the nine image tiles of FIG. 4 and adjusted in FIG. 5 with tile edges darkened on a gradient curve.

### DETAILED DESCRIPTION OF THE INVENTION

In accordance with the present application, the described system and method provides a technique for capturing a single, unified image using an image capture sensor including a plenoptic lens. The described system and method also provides a technique for displaying a single, unified image on a display device including a plenoptic lens. In either the image capture sensor or the display device application, the plenoptic lens may be an integral part of the image capture sensor or the display device, for example, as a layer within the sensor and/or display, or may be an added component within the system. For example, the plenoptic lens may be an additional lens or component that is placed within the image capture field between the image and the image capture sensor or the image display field between the display and an eye of the user.

The at least one plenoptic lens may be made up of a plurality of light-directing beads, also referred to as mini-lenses, microlenses, or lenslets. Additional details regarding the Foveal lens when used in both display and capture systems, and background information regarding the lenslets can be found in commonly owned U.S. Pat. Application Serial No. 16/436,343, filed Jun. 10, 2019, and titled “NEAR-EYE FOVEAL DISPLAY”, which is a continuation-in-part of U.S. Pat. Application Serial No. 15/671,694, filed Aug. 8, 2017, and titled “NEAR-EYE FOVEAL DISPLAY”, which is a continuation-in-part of U.S. Pat. Application Serial No. 15/594,029, filed May 12, 2017, and titled “NEAR-EYE FOVEAL DISPLAY”, the contents of which are incorporated by reference herein.

The lenslets as described in the above applications each capture an integral image that is in full focus. However, the described system can be utilized with other plenoptic lenses that may not capture full focus images. This disclosure will refer to lens tiles which are associated with the lenslets of the plenoptic lens. The lenslets refer to a physical hardware component that makes up the plenoptic lens. The term “lens tile” refers to the same component and will be used interchangeably here throughout. The term “image tile” will also be used here throughout. Image tile refers to the section of the image on the display or the sensor that can be seen, or captured, through a corresponding lens tile. The image tile and the lens tile are not the same: one is shown through the other. The image tile may be calibrated and its shape changed with software as taught herein.

Since each lenslet is small, the plenoptic lens or lens array includes a multiplicity of lenslets. As an example used for illustrative purposes only, the lenslets are approximately 3 mm square and may, in an embodiment, be placed over an approximately half-inch sensor or display, yielding a total of 12 lenslets in the array used for both capture and display; and both the lens array and the sensor or display are flat on the surfaces facing each other. Thus, the resulting lens, or arrays of lenslets, is a high-resolution lens that is not found within conventional image capture device lenses or display devices. The range of view of each lenslet may be a conical shape radiating from the lens. Since the optics of each lenslet are known, the areas of overlap between all the lenslets in the array is also known. Using this information, the system can identify a position of an object with respect to the lens, for example, an object being captured within the image or an object being displayed on a display device. Knowing the position of the objects on X, Y, and Z axes in relation to the lens array and underlying sensor, the system is able to provide additional functions that are not possible using conventional techniques, as described further herein. Additionally, the described system and method utilizes information corresponding to a user to further refine the displayed image and/or captured image to make the image of even better quality as compared to conventional systems.

Using the plenoptic lens in conjunction with an image capture sensor or display device results in multiple images being captured (for image capture) or generated (for image display). Specifically, each lenslet in the plenoptic lens captures or shows an image. Since multiple lenslets exist within the plenoptic lens, multiple images are generated or captured. Additionally, based upon the shape of the lenslets and location of the lenslets with respect to one another, information captured or generated by each lenslet will overlap with information captured or generated by neighboring lenslets. Thus, the image information captured or generated will include redundant image data information. Additionally, generally, more overlap will occur when the user is closer to the display device or when the image capture sensor is closer to the image that is being captured. Thus, the described system and method provides a technique to address the overlapping information and address any distortions or image defects that are present to create a single, unified image from the multiple images created through the use of the plenoptic lens.

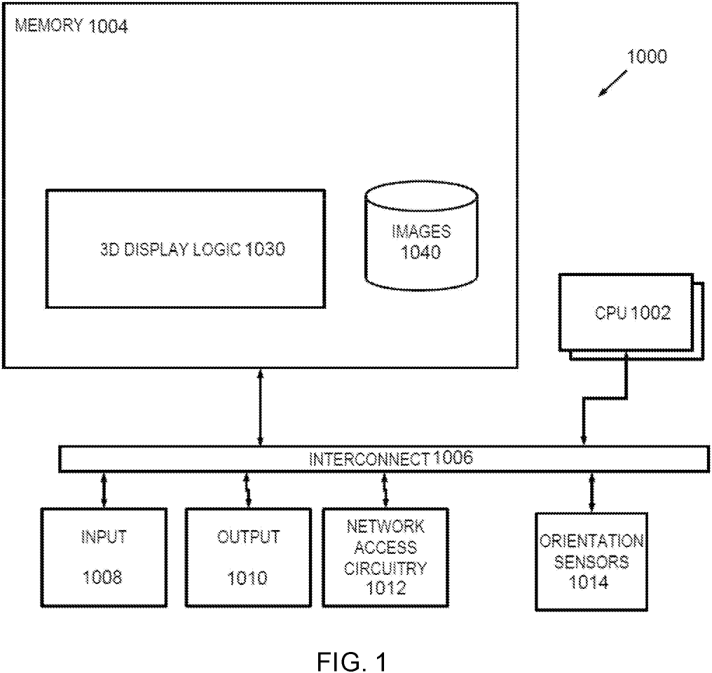

Referring to FIG. 1, a device 1000, for example, that which is used for the viewing apparatus, is described. The device 1000 includes one or more microprocessors 1002 (collectively referred to as CPU 1002) that retrieve data and/or instructions from memory 1004 and execute retrieved instructions in a conventional manner. Memory 1004 can include any tangible computer readable media, e.g., persistent memory such as magnetic and/or optical disks, ROM, and PROM and volatile memory such as RAM.

CPU 1002 and memory 1004 are connected to one another through a conventional interconnect 1006, which is a bus in this illustrative embodiment and which connects CPU 1002 and memory 1004 to one or more input devices 1008 and/or output devices 1010, network access circuitry 1012, and orientation sensors 1014. Input devices 1008 can include, for example, a keyboard, a keypad, a touch-sensitive screen, a mouse, and a microphone. An embodiment may include an input device such as a camera or photosensor used for eye-tracking. Eye tracking that is then associated with computer-activation of particularly chosen pixels is a typical implementation of the invention when used in a near-eye display and other embodiments, as volumetric capture makes for more accurate tracking of eye movements. Output devices 1010 can include one or more displays - such as an OLED (organic light-emitting diode), a microLED, or liquid crystal display (LCD), or a printed image of sufficiently high resolution - and one or more loudspeakers for associated audio. Network access circuitry 1012 sends and receives data through computer networks. Orientation sensors 1014 measure orientation of the device 1000 in three dimensions and report measured orientation through interconnect 1006 to CPU 1002. These orientation sensors may include, for example, an accelerometer, gyroscope, and the like, and may be used in identifying the position of the user.

Information handling device circuitry, as for example outlined in FIG. 1, may be used in image capture devices such as video cameras, digital still-image cameras, analog cameras, or other cameras having lenses, devices that may be utilized to process images such as tablets, smart phones, personal computer devices generally, devices that may be used to display images such as televisions, billboards, personal computer devices generally, and/or other electronic devices.

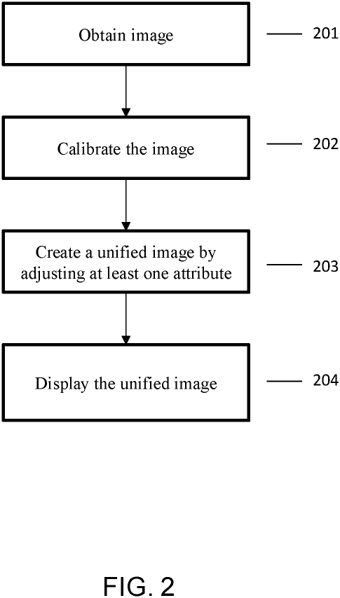

FIG. 2 illustrates an example method for displaying a unified image on a display device including a plenoptic lens. The system obtains an image for display on a display device including a plenoptic lens at 201. It should be noted that the display may include one or more plenoptic lenses. It should also be noted that what is referred to herein as “the display” may be made up of a number of smaller displays seen through one or more plenoptic lens arrays. In the event that the system includes more than one plenoptic lens, information from each lens is combined into the single, unified image as discussed in more detail further herein. In other words, the number of plenoptic lenses and, correspondingly, the number of lenslets either within a single plenoptic lens or across multiple plenoptic lenses does not affect the ability of the described system and method to combine the images from each lenslet into a single, unified image. The image may be a still image or dynamic image. The example of a video for display on a television set or other electronic device having a display (e.g., smartphone, tablet, television set, smart television, billboard, etc.) will be used here throughout. However, this example is not intended to limit the scope of this disclosure to a dynamic image or a television display. Obtaining the image may include receiving the image at the system, accessing a data storage location containing the image, or any other technique for obtaining information.

At 202 the system calibrates the image in view of properties of the at least one plenoptic lens. The calibration may also be referred to as creating a baseline setting for the image. The calibrating includes centering the image tiles corresponding to portions of the image on corresponding lens tiles of the plenoptic lens(es). For readability a single plenoptic lens having multiple lenslets will be used here throughout. However, this is not intended to limit this disclosure to a single plenoptic lens having multiple lenslets. To center image tiles, the system first creates image tiles. The system measures the resolution in pixels and both horizontally and vertically of the incoming image, or, using the example introduced above, the incoming video signal. The system also measures the actual size and resolution of the usable area of the display that the image is to be displayed upon. The usable display area is divided into sections corresponding to the size of each lens tile.

The distance, both actual physical distance and pixel distance, between center points of each lens tiles is calculated. Stated differently, the system calculates the distance, both physical and pixel, on the display surface from center point to center point of each lens tile. The incoming video is divided into a number of image tiles equal to the number of lens tiles. The image tiles have at maximum the same shape and same actual size as the lens tiles of the plenoptic lens. However, they may be shaped differently (within a maximum of the dimensions of the associated lens tile) and may be smaller than the lens tile that the image tile is associated with. In other words, the image is divided into sections called image tiles and that match the lens tiles in number, in maximum size, and maximum two-dimensional area of the lens tiles of the plenoptic lens. Each image tile is centered on the same point as a corresponding lens tile. Thus, the calibration and, specifically, the centering of the image tiles on the lens tiles is performed in view of properties of the plenoptic lens, where some of the properties include the size of the lens tiles of the plenoptic lens, the distance between center points of the lens tiles, a number of lens tiles, and the like. The result of this calibration step is a baseline setting for the image tiles and lens tiles.

At 203 the system creates a unified image from the image tiles of the calibrated image. In other words, the system utilizes the image tiles that were created and calibrated at step 202 to create the unified image. Creating the unified image includes adjusting at least one attribute of the image tiles to control a portion of the image displayed through each of the lens tiles of the plenoptic lens. The adjusting is also based upon a distance range of an eye of a user to the display device. In order to distinguish between different steps, the term attribute will be used when discussing adjustment of the image tiles where the adjustment is also based upon a distance of the eye of the user to the display device. This is distinguished from the term characteristic which is used when discussing adjustment of either an image tile or lens tile where the adjustment is not based upon the distance of the eye of the user to the display device.

Since adjustment of the attribute is based upon a distance of the eye of the user from the display device, the system may capture, using a gaze tracking system, camera, distance calculation device, or the like, a distance of the eye of the user from the display device. Different distance measurement devices and/or algorithms may be employed. This may be not be necessary for certain embodiments in which the lens and display are commonly expected to be used within a typical range of distance from the eye, for example, within the range of normal eyeglasses. Additionally, in the case that a more sophisticated system that provides additional data is utilized, for example, a gaze tracking system which can not only identify a distance of an eye of the user to the display but also a specific location where the user is looking, the system may use the additional information to perform other optimization functions, for example, power optimization, foveated rendering, display brightness optimization, and the like.

Creating the unified image may be a dynamic process that is based upon the distance and/or location of the eye of the user with respect to the display device. In other words, the system may dynamically determine, in real-time or substantially real-time, while the user is viewing the display device, the distance and/or location of the eye of the user with respect to the display device. Based upon this information the system creates the unified image. Since the distance and/or location of the eye of the user can change while the user is viewing the display device, the system can dynamically create the unified image based upon the real-time distance and/or location of the eye of the user with respect to the display device. In other words, the system can be continually updating the unified image as the user is viewing the image to make the image optimized for the distance and/or location of the eye of the user with respect to the display device.

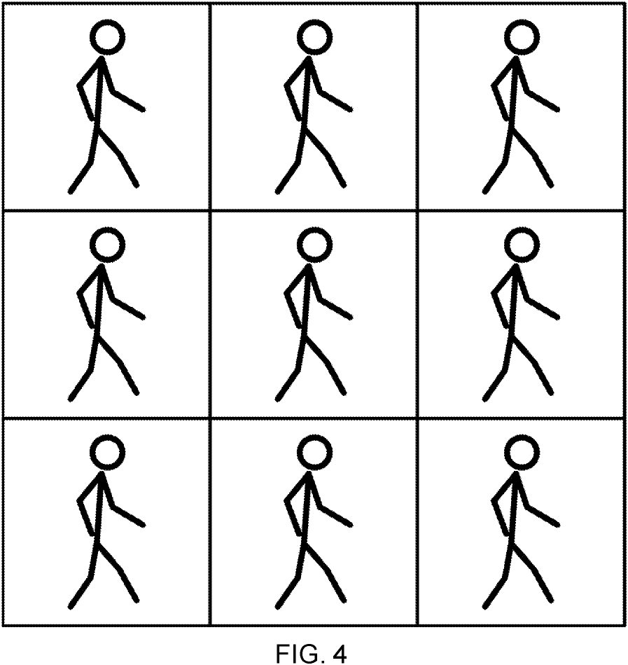

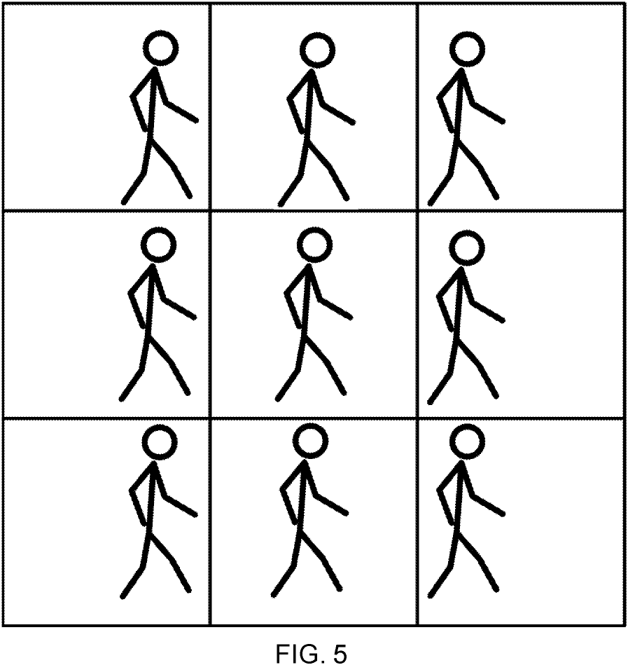

FIG. 4 illustrates a view of nine image tiles, each showing exactly the same image. This illustration will be the base set of images that are adjusted in the remaining FIGS. 5 -11. FIG. 5 illustrates a view of the nine image tiles of FIG. 4, but with the image centers displaced such that their centers converge when viewed from a typical near-eye distance through the magnifying plenoptic lens.

Different attributes that may be adjusted include image tile size and attributes that contribute to image distortion. In other words, the attribute that is adjusted may be chosen to compensate for image distortion, for example, pincushion or barrel distortion, trapezoidal distortion, and tile spread distortion. Adjustment of image tile size may include overall image tile size and concentric tile size. Adjusting the overall image tile size includes adjusting the image tile size to be some multiple of the actual size that the tile represents as a portion of the overall image. In other words, it is to be expected that the portion of the overall image shown in each tile will be larger than its proportional share of the overall image, such that the multiple tiles will show largely (but not completely) overlapping images. Generally, because the plenoptic lens in a common embodiment is a magnifying lens with image magnification increasing as the eye moves farther from the display. The closer the eye of the user is to the display device, the less the amount of image overlap from one tile to the next. Therefore, the ratio of the image tiles’ height and width to their center-to-center distance is controlled and adjusted. Since the amount of overlap varies with a distance from an eye of a viewer to the display device, the adjustment of the ratio may be varied based upon the real-time detected distance and/or location of the eye of the viewer.

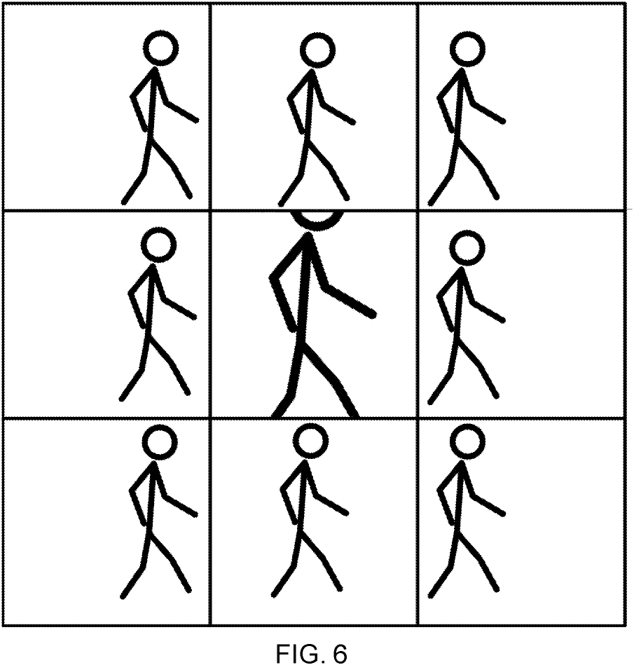

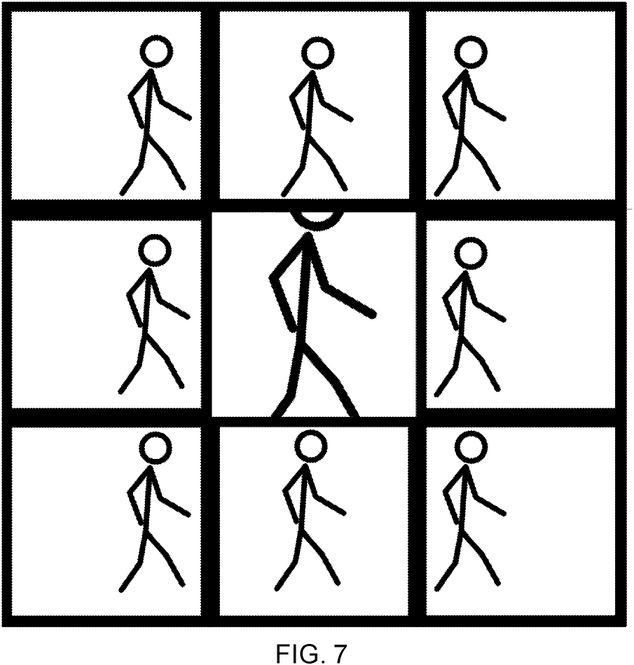

Adjusting the concentric tile size includes adjusting the relative sizes of each image tile proportionally to the distance of the eye to that particular tile. Specifically, in a common embodiment in which the plenoptic lens is a magnifier, if image tile size is left unchanged as the eye moves farther form the display then the overall multi-tile image will be seen to zoom in on a small area of the overall display; the relative image tile sizes must increase proportionally as the distance to the eye of the viewer increases. This is due to the fact that the optics used in the system increase image magnification as the distance of the eye of the viewer to the display device increases in order to maintain the same effective focal length of the image as seen by the user. In a near-eye display, the difference in magnification between an image tile at the center of a user’s field of vision and one located even just next to that tile, and certainly with a tile at the far edge of the field of view, will be of ever greater significance. Therefore, the system adds to or subtracts from the value of image tile size based on a given tile’s location in concentric rings from the center tile. Such adjustment is illustrated in FIG. 6 and FIG. 7. FIG. 6 illustrates the set of nine image tiles of FIG. 4 and as previously adjusted in FIG. 5, with the center tile image enlarged to compensate for the greater magnification created by more distance from the eye to the outer lens tiles. FIG. 7 illustrates the set of nine image tiles of FIG. 4 and as previously adjusted in FIG. 5 and FIG. 6, with all tiles surrounding the center tile reduced in size to compensate for their greater magnifications because of greater distance from the eye centered on the center tile. As with the overall image tile size, the adjustment of the concentric tile size is varied based upon the real-time detected distance and/or location of the eye of the viewer. Additionally, since the center tile changes as the gaze of the user moves on the display, real-time gaze tracking information may be used to vary the adjustment of the concentric tile size.

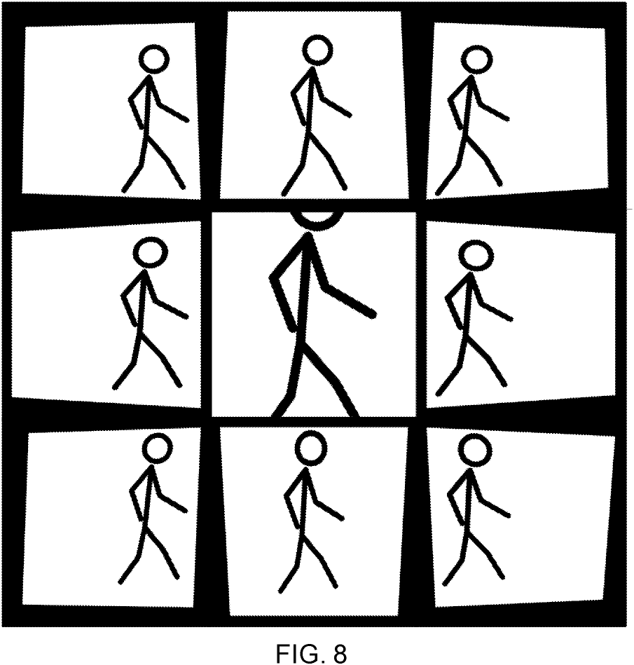

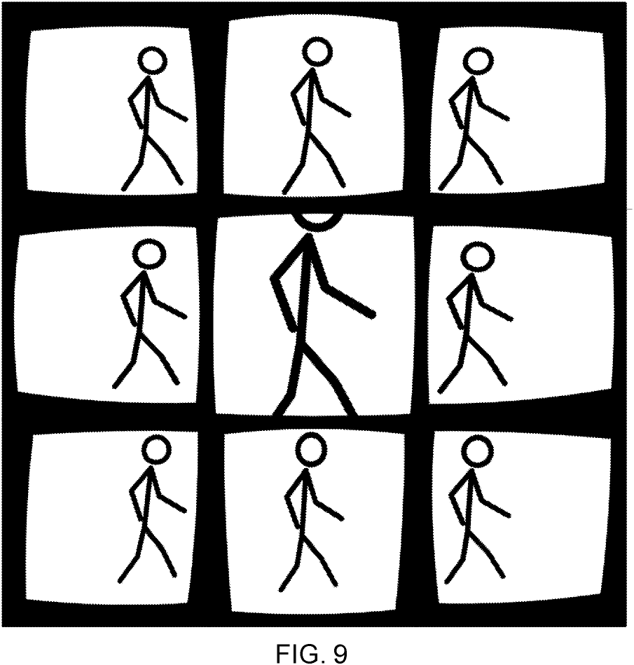

Compensating for image distortion includes adjusting for barrel or pincushion distortion. The lens tiles feature a spherical lens shaved by four equal chords into a square tile which necessarily creates some amount of pincushion or barrel distortion for the image. The amount of pincushion or barrel distortion (referred to as pincushion distortion for ease of readability) depends on the distance from the eye to the display, so the pincushion distortion compensation occurs in real-time as distance and/or location information of the eye with respect to the display device is received. To compensate for the pincushion distortion, per-tile coordinates are normalized to [-1, 1], then distorted texture coordinates (x_d, y_d) are calculated as:

$$\text{x\_d = x *} \left(1 + \text{k * r}\right)$$

$$\text{y\_d = y *} \left(1 + \text{k * r}\right)$$

where (x, y) are the normalized undistorted coordinates, r = x^2 + y^2, and k is the distortion coefficient. The pincushion distortion may be somewhat more complicated than this, because pincushion distortion affects different light wavelengths differently. Depending on pixel size and viewing distance, red, blue and green distortions will be more or less noticeable, and can, therefore, be corrected individually for each color channel, for example, when correcting for a near eye display with fine resolution. Since the same sort of pincushion distortion can affect the overall field of view through the totality of the lens tiles in the plenoptic lens, the same calculations can be utilized for the same overall image as seen through all lens tiles. This overall pincushion distortion calculation, like the tile pincushion distortion calculation, varies based upon distance and/or position information received. The tiles of FIG. 4 adjusted for pincushion distortion are illustrated in FIG. 9. FIG. 9 illustrates the tiles of FIG. 4 and as previously adjusted in FIG. 5, FIG. 6, FIG. 7, and FIG. 8 (discussed below), with pincushion distortion added for each image tile to compensate for the natural pincushion distortion created by each spherical lens.

Another type of image distortion is trapezoidal distortion. In a near-eye system, the apparent image size towards the edge of the field of view will be different enough from the apparent image size towards the center that each image tile not located at the center of the image (with respect to the distance and location of the eye on the display) will appear as a trapezoid, and increasingly so in concentric rings outward from the center of the display. Therefore, a trapezoidal texture projection for each tile is applied that increases from the center of the display outward (or, when gaze tracking and dynamic adjustments are used, from the center tile viewed by the user outward). The trapezoidal texture projection is also adjusted for the position of the tile relative to the center. This trapezoidal texture projection is performed by giving each tile a set of four coordinates {(x1, y1), (x2, y2), (x3, y3), (x4, y4)} to correspond to each of the four corners of the tile. The tile values start as {(0, 0), (1, 0), (1, 1), (0, 1)} when trapezoidal distortion is set to 0, and changing the value for trapezoidal distortion adds to or subtracts from the values as appropriate, based on the tile’s position with respect to the center tile. A system of eight linear equations with eight unknowns is used to solve for a 4×4 texture matrix, which is then multiplied by the original texture coordinates <s, t, r, q> to compute the distorted coordinates <s′, t′, r′, q′>. The system of equations is as follows:

$$\text{x1 = c}$$

$$\text{y1 = f}$$

$$\text{x2 = a + c - x2*g}$$

$$\text{y2 = d + f - y2*g}$$

$$\text{x3 = a + b + c - x3*g - x3*h}$$

$$\text{y3 = d + e + f - y3*g - y3*h}$$

$$\text{x4 = b + c - x4*h}$$

$$\text{y4 =e + f - y4*h}$$

The 4x4 texture matrix is then constructed from these eight unknowns as follows:

$$\text{a b 0 c}$$

$$\left|\text{d e 0 f}\right|$$

$$\left|0 0 1 0\right|$$

$$\left|\text{g h 0 l}\right|$$

Finally, the new distorted texture coordinates <s′, t′, r′, q′> are computed by multiplying the texture matrix and the original texture coordinates as follows:

$$\left|{\text{s}}^{′}\right| = \left|\text{a b 0 c}\right| \left|\text{s}\right|$$

$$\left|{\text{t}}^{′}\right| = \left|\text{d e 0 f}\right| \left|\text{t}\right|$$

$$\left|{\text{r}}^{′}\right| = \left|0 0 1 0\right| \left|\text{r}\right|$$

$$\left|{\text{q}}^{′}\right| = \left|\text{g h 0 1}\right| \left|\text{q}\right|$$

As with the other attributes, this trapezoidal distortion calculation varies based upon received distance and/or position information. The tiles of FIG. 4 adjusted for trapezoidal distortion are illustrated in FIG. 8. FIG. 8 illustrates the tiles of FIG. 4 and as previously adjusted in FIG. 5, FIG. 6, and FIG. 7, with all tiles surrounding the center tile adjusted to compensate for trapezoidal distortion caused by greater image magnification at larger distances from the eye.

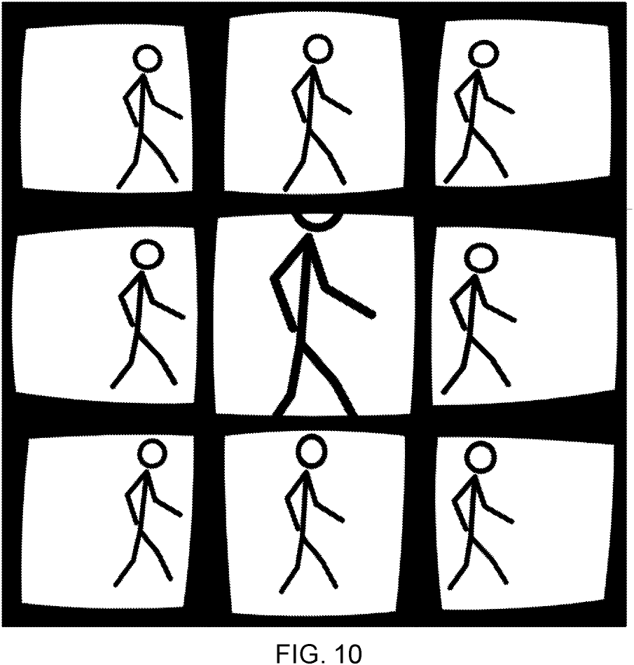

Another type of distortion is referred to as tile spread. There will be increasingly apparent differences between concentric rings of image tiles in terms of where the tile center is situated in relation to the center tile. These differences are created by the different and increasing angle at which the eye sees image tiles as they are presented farther from the center of the field of view, referred to as the center tile. To compensate for this, the amount of space between each tile is controlled by an amount proportionate to the size of the lens tile. For example, at 0% compensation, there is no space between each tile. At 50%, the size of the space between tiles is equal to half the size of a tile. At 100%, the size of the space between tiles is equal to the size of a tile. Since the center tile changes based upon the distance and/or position of the eye to the display device, this calculation varies based upon the distance and/or position information received. The tiles of FIG. 4 adjusted for tile spread are illustrated in FIG. 10. FIG. 10 illustrates the tiles of FIG. 4 and as previously adjusted in FIG. 5, FIG. 6, FIG. 7, FIG. 8, and FIG. 9, with distances from the center lens spread out to compensate for viewing angle and distance through the lens array.

While all of the above attribute adjustments are based upon a distance and/or position of the eye of the user with respect to the display, it should be understood that real-time distance and/or position information may not be available in all systems and/or applications. Accordingly, the system can utilize periodical distance and/or position information, estimated or predicted distance and/or position information, or any other variation of distance and/or position information. However, the best quality unified image will result from having real-time or substantially real-time eye distance and/or position information.

As can well be appreciated, all of the above compensations interact such that more or less adjustment in one area creates more or less apparent need for adjustment in another. While the precise distances from eye to lens array and from lens array to display, as well as the overall size of the lens array and display, will determine easily calculable optimal settings, in fact the areas of divergence from optimal settings in all of these parameters, in which images will still appear to look good—even to look perfect—are quite wide. This creates a wide zone for viewing, in terms of eyebox and eye relief, and also in terms of the geometry of the eye (those with myopia or presbyopia, or other conditions, with longer or shorter focal distances to the retina, or somewhat different viewing angles at which images appear in best focus), such that the viewer will naturally position the lens to a distance from the eye without conscious effort—just as viewers do when positioning normal corrective eyeglasses—and see images in proper focus even if the above compensations might be slightly off of geometric perfection. However, subtle imperfections may not be consciously noticeable but be subconsciously noticed, such that extended viewing times may build user tedium and eyestrain. Therefore, though acceptable adjustment of the above parameters may be achieved without tracking the exact position of the eye, optimal adjustment (and thus constant re-adjustment) is only possible when combined with gaze tracking of the viewer’s pupil.

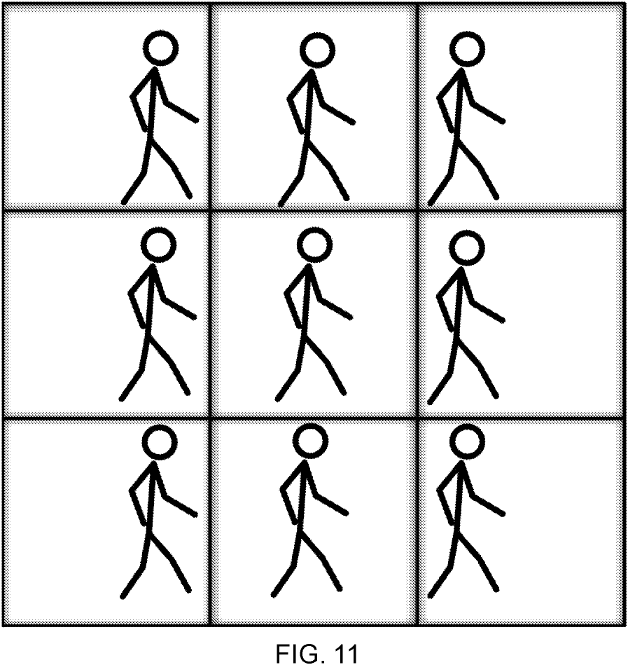

In addition to adjusting the attributes, the system can also modify at least one characteristic of either the image tile, lens tile, or a combination of both. This characteristic modification assists in changing the quality of the image and is not necessarily dependent upon the distance and/or position of the eye of the viewer with respect to the display device. These modifications include “screen-door” correction per lens tile, fine alignment of lens to underlying display, zoom, and/or the like. The term “screen-door” commonly denotes the appearance of an image composed of more or less blocky pixels. With a plenoptic lens we see a different sort of, but similar-looking, screen-door distortion caused by spherical lenses shaved into rectangular tiles, which will naturally present differential light intensity to the eye at the lens tile center versus the lens tile edge. Therefore, the system darkens the edges of the tiles relative to the centers of the tiles. This effect is calculated using the per-tile coordinates normalized to [-1, 1]. The calculation is then performed as follows:

$$\text{z = max} \left(\left|\text{x}\right| , \left|\text{y}\right|\right)$$

$$\text{f = min} \left(0.5 * \left(\text{r + c\_r * c\_loc}\right) * cos \left(π * \text{z}\right) + 1 , 1\right)$$

$$\text{fragColor =} \left(\text{fragColor}\right) * \left(\text{f}\right)$$

where (x, y) are the normalized per lens tile coordinates, r is the brightness reduction coefficient, c_r is the concentric brightness reduction coefficient, and c_loc is the concentric ring in which the lens tile is located. The brightness function f is taken as the minimum of 0.5*(r + c_r * c_loc)*cos(πz)+1 and 1 to give a result that maxes out at 1 to prevent washing out the image. The tiles of FIG. 4 adjusted for the screen-door effect are illustrated in FIG. 11. FIG. 11 illustrates the tiles of FIG. 4 and as previously adjusted in FIG. 5, with the tile edges darkened on a gradient curve to compensate for apparent brightness differences caused by the shaved spherical lens tiles.

Fine alignment of the lens to an underlying display is performed in view of the fac that the lens and display (or lens and image capture sensor) may not be perfectly aligned during assembly of the hardware. Accordingly, the translation and rotation components of the model matrix of the final display’s vertices can be adjusted. The translation controls may move the display by one pixel per press, per knob ratchet, or any similar digital control, and this alignment may also be automated through the use of alignment patterns shown on the display and read be a sensor. The rotation controls rotate the display by 0.1 degrees per press, ratchet, or the like, or in a similar automated fashion using alignment patterns and a sensor. Zooming can be performed on an image tile basis, not only an overall image basis. In other words, the digital zoom with a plenoptic lens system zooms in or out per each image tile, not only the overall image as one.

Once the unified image is created at 203, the system displays the unified image on the display device at 204. In other words, the unified image is presented to a user for viewing. As discussed above, the unified image may be updated as the gaze of the user moves or as the distance of the user with respect to the display device changes, thereby providing a dynamic unified image. Also, as discussed above, the image updating occurs as frequently as the distance and/or position information is updated. Therefore, if the distance and/or position information is not updated frequently, the unified image does not need to be updated as frequently. However, the frequency of updating the unified image does not have to match the frequency of receipt of the distance and/or position information.

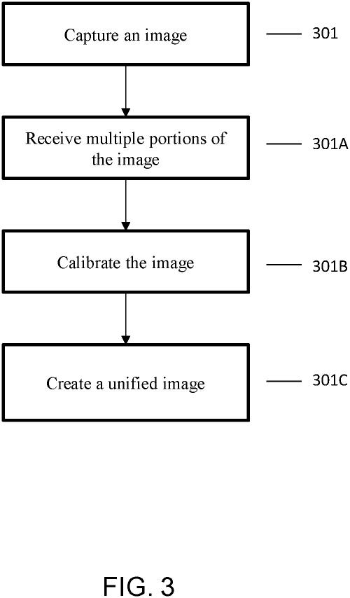

FIG. 3 illustrates an example method of capturing an image using an image capture sensor having at least one plenoptic lens. Capturing the image at 301 includes receiving multiple portions of the image at 301A. Each of the multiple portions of is generated by a lens tile of the plenoptic lens. The image is calibrated at 301B in view of properties of the plenoptic lens. Calibrating includes centering the image tiles on corresponding lens tiles of the plenoptic lens. The calibration is the same as described in connection with step 202 above. However, instead of the display, the image capture sensor is used in the calibration. For example, instead of measuring the usable area of the display, the system measures the usable area of the image capture sensor.

At 301C, the system creates a unified image for capture from the image tiles of the calibrated image. As with step 203, the unified image creation is performed by adjusting at least one attribute of the image tiles to control a portion of the image captured through each of the lens tiles. Instead of being based upon a distance of the eye of the user to the display device, the adjusting for capturing an image is based upon a distance of the at least one image capture sensor to the image to be captured. In other words, the description provided in connection with step 203 applies to step 301C with the exception that instead of the distance of the eye to the display device, the distance between the image capture sensor and the image is utilized. In addition to the attribute adjustments, the system can also perform the characteristic modifications described above. After all adjustments and modification are performed, the image capture sensor captures and saves the unified image.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. A method, comprising;
obtaining an image for display on a display device comprising at least one plenoptic lens;
calibrating the image in view of properties of the at least one plenoptic lens, wherein the calibrating comprises centering image tiles corresponding to portions of the image on corresponding lens tiles of the at least one plenoptic lens;
creating a unified image from the image tiles of the calibrated image by adjusting at least one attribute of the image tiles to control a portion of the image displayed through each of the lens tiles of the at least one plenoptic lens, wherein at least a portion of the adjusting is based upon a distance of an eye of a user to the display device; and
displaying the unified image on the display device comprising the at least one plenoptic lens.

2. The method of claim 1, wherein the adjusting at least one attribute comprises adjusting a size of each of the image tiles to a multiple of a size of the portion of the image represented by the image tile.

3. The method of claim 1, wherein the adjusting at least one attribute comprises compensating for image distortion by adjusting the at least one attribute.

4. The method of claim 3, wherein the image distortion comprises at least one of: pincushion distortion, trapezoidal distortion, and tile spread.

5. The method of claim 1, wherein the adjusting at least one attribute is an iterative process based upon adjustment of attributes.

6. The method of claim 1, wherein the creating comprises changing a quality of the image by modifying at least one characteristic of at least one of an image tile and a lens tile.

7. The method of claim 1, wherein the calibrating comprises creating the image tiles by dividing the image into a number of image tiles matching a number of the lens tiles.

8. The method of claim 7, wherein each of the image tiles is adjusted to have the same shape and size as the lens tiles.

9. The method of claim 1, wherein the calibrating is based upon a resolution and a size of the display device.

10. The method of claim 1, comprising dynamically determining, while the user is viewing the display device, a location of the eye of the user with respect to the display device and wherein the creating is performed dynamically based upon the determined dynamic location.

11. A method, comprising:
capturing, using at least one image capture sensor comprising at least one plenoptic lens, an image, wherein the capturing comprises:
receiving multiple portions of the image, wherein each of the multiple portions is generated by a lens tile of the at least one plenoptic lens;
calibrating the image in view of properties the at least one plenoptic lens, wherein the calibrating comprises centering image tiles on corresponding lens tiles of the at least one plenoptic lens, each of the image tiles corresponding to one of the multiple portions of the image; and
creating a unified image from the image tiles of the calibrated image by adjusting at least one attribute of the image tiles to control a portion of the image captured through each of the lens tiles, wherein at least a portion of the adjusting is based upon a distance of the at least one image capture sensor to the image.

12. The method of claim 11, wherein the adjusting at least one attribute comprises adjusting a size of each of the image tiles to a multiple of a size of the portion of the image represented by the image tile.

13. The method of claim 11, wherein the adjusting at least one attribute comprises compensating for image distortion by adjusting the at least one attribute.

14. The method of claim 13, wherein the image distortion comprises at least one of: pincushion distortion, trapezoidal distortion, and tile spread.

15. The method of claim 11, wherein the adjusting at least one attribute is an iterative process based upon adjustment of attributes.

16. The method of claim 11, wherein the creating comprises changing a quality of the image by modifying at least one characteristic of at least one of an image tile and a lens tile.

17. The method of claim 11, wherein the calibrating comprises creating the image tiles by dividing the image into a number of image tiles matching a number of the lens tiles.

18. The method of claim 7, wherein each of the image tiles is adjusted to have the same shape and size as the lens tiles.

19. An information handling device, comprising;
a gaze detection sensor;
a display;
at least one plenoptic lens disposed on the display, wherein each of the at least one plenoptic lens comprises a plurality of lens tiles that cover a portion of the display;
a processor;
a memory device that stores instructions executable by the processor to:
obtain an image for display on the display device;
calibrate the image in view of properties of the at least one plenoptic lens, wherein the calibrating comprises centering image tiles corresponding to portions of the image on corresponding of the plurality of lens tiles of the at least one plenoptic lens;
create a unified image from the image tiles of the calibrated image by adjusting at least one attribute of the image tiles to control a portion of the image displayed through each of the lens tiles of the at least one plenoptic lens, wherein at least a portion of the adjusting is based upon a distance of an eye of a user to the display device as detected using the gaze detection sensor; and
display the unified image on the display device.

20. The information handling device of claim 19, wherein the adjusting at least one attribute is an iterative process based upon adjustment of attributes.
